(19) United States
(12) Patent Application Publication
(10) Pub. No.: US 2023/0212440 A1
(43) Pub. Date: Jul. 6, 2023

(54) ADHESIVE COMPOSITION AND WAFER PROCESSING TAPE INCLUDING THE SAME

(71) Applicant: SAMSUNG ELECTRONICS CO., LTD., Suwon-si (KR)

(72) Inventors: CHEONIL PARK, SEONGNAM-SI (KR); MYOUNGCHUL EUM, ASAN-SI (KR); HWAIL JIN, SEONGNAM-SI (KR)

(21) Appl. No.: 18/088,856

(22) Filed: Dec. 27, 2022

(30) Foreign Application Priority Data
Jan. 3, 2022 (KR) 10-2022-0000509

(51) Int. Cl. C09J 133/08; C09J 7/38; C09J 7/29; C09J 7/25; B32B 7/12; B32B 27/28; B32B 27/32; B32B 27/36; B32B 27/08

(52) U.S. Cl. CPC C09J 133/08; C09J 7/385; C09J 7/29; C09J 7/255; B32B 7/12; B32B 27/285; B32B 27/281; B32B 27/32; B32B 27/36; B32B 27/08; B32B 2307/732; B32B 27/308

(57) ABSTRACT

An adhesive composition includes a resin, a crosslinking agent, and a light absorber. The light absorber includes at least one selected from the group consisting of a benzophenone-based compound, a cyanoacrylate-based compound having a ring structure, a benzotriazole-based compound, and a sterically hindered amine compound having a ring structure.

### CROSS-REFERENCE TO RELATED APPLICATION

A claim of priority under 35 U.S.C. § 119 is made to Korean Patent Application No. 10-2022-0000509, filed on Jan. 3, 2022, in the Korean Intellectual Property Office, the disclosure of which is incorporated by reference herein in its entirety.

### BACKGROUND

The present inventive concepts relate to adhesive compositions and to wafer processing tapes including adhesive compositions. More specifically, the present inventive concepts relate to adhesive compositions having a light absorber that absorbs ultraviolet rays of a given wavelength or less, and to wafer processing tapes including the same.

In the manufacture of semiconductor devices, a dicing process is typically carried out to separate a wafer into individual chips. Here, a wafer processing tape may be adhered to a surface of the wafer in order to avoid scattering of the separated chips upon completion of dicing. However, during manufacture, the wafer processing tape may be exposed to ultraviolet light which can chemically decompose the tape. The resultant contaminants can cause damage to the chips and reduce device reliability.

### SUMMARY

According to an aspect of the inventive concepts, an adhesive composition includes a resin, a crosslinking agent, and a light absorber, wherein the light absorber includes at least one selected from the group consisting of a benzophenone-based compound, a cyanoacrylate-based compound having a ring structure, a benzotriazole-based compound, and a sterically hindered amine-based compound having a ring structure.

According to another aspect of the inventive concepts, an adhesive composition includes an acrylate-based resin, an isocyanate-based crosslinking agent, a first light absorber, and a second light absorber, wherein the first light absorber and the second light absorber include at least one selected from the group consisting of a benzophenone-based compound, a cyanoacrylate-based compound having a ring structure, a benzotriazole-based compound, and a sterically hindered amine-based compound having a ring structure, and the first light absorber and the second light absorber are different from each other.

According to yet another aspect of the inventive concepts, a wafer processing tape includes a base film, and an adhesive composition layer located on the base film and including a resin, a crosslinking agent, and a first light absorber, wherein the first light absorber includes at least one selected from the group consisting of a benzophenone-based compound, a cyanoacrylate-based compound having a ring structure, a benzotriazole-based compound, and a sterically hindered amine compound having a ring structure.

### BRIEF DESCRIPTION OF THE DRAWINGS

Embodiments of the inventive concepts will be more clearly understood from the following detailed description taken in conjunction with the accompanying drawings in which:

FIG. 1 is a cross-sectional view showing a wafer processing tape according to an embodiment of the inventive concepts;

FIG. 2 is a flowchart for reference in describing a wafer processing method using a wafer processing tape according to an embodiment of the inventive concepts; and

FIGS. 3A to 3I are cross-sectional views for reference in describing operations of a wafer processing method using a wafer processing tape according to an embodiment of the inventive concepts.

### DETAILED DESCRIPTION OF THE EMBODIMENTS

Hereinafter, embodiments of the present inventive concepts will be described in detail with reference to the accompanying drawings. The same reference numerals are used to indicate like components throughout the drawings, and duplicate descriptions thereof are omitted.

Hereinafter, unless otherwise defined, a length in a direction parallel to an upper surface of a wafer processing tape 100 is referred to as a horizontal width, and a length in a direction perpendicular to the upper surface of the wafer processing tape 100 is referred to as a vertical thickness.

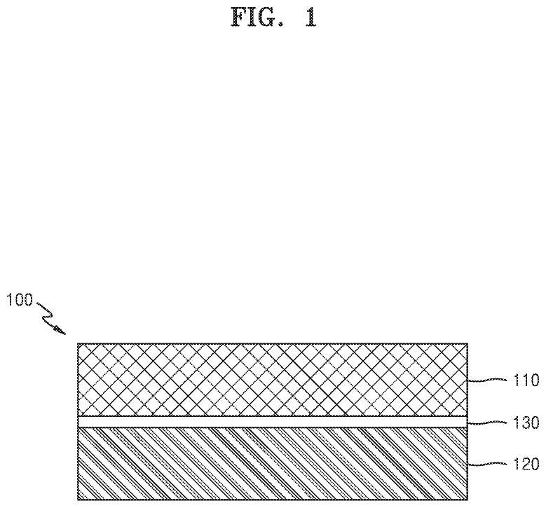

FIG. 1 is a cross-sectional view showing a wafer processing tape 100 according to an embodiment of the inventive concepts.

Referring to FIG. 1, the wafer processing tape 100 may include an adhesive composition layer 110 and a base film 120. The adhesive composition layer 110 may be disposed on the base film 120. The adhesive composition layer 110 may have a horizontal width which is the same as a horizontal width of the base film 120. In an embodiment, the base film 120 may include any one of polyether ether ketone (PEEK), polyamide (PI), polyethylene naphthalate (PEN), polyolefin (PO), and polyethylene terephthalate (PET), but the inventive concepts are not limited to these examples. In addition, the base film 120 may include a material capable of absorbing ultraviolet rays having a wavelength of 350 nm or less. Accordingly, when there is no light absorber in the adhesive composition layer 110, the base film 120 may absorb ultraviolet rays having a wavelength of 350 nm or less which may cause the base film 120 to be chemically decomposed. In an embodiment, the base film 120 may have a single-layer structure or a multi-layer structure in which two or more layers are stacked. A surface of the base film 120 may have a surface-treatment. The surface treatment may be, for example, a corona treatment, a primer treatment, etc., but the inventive concepts are not limited in this manner.

The adhesive composition layer 110 according to an embodiment of the inventive concept may include a resin, a crosslinking agent, and a light absorber.

In an embodiment, the resin may include an acrylate-based resin. The acrylate-based resin may include, for example, methyl(meth) acrylate, ethyl(meth) acrylate, n-butyl(meth) acrylate, isobutyl(meth) acrylate, t-butyl(meth) acrylate, isobornyl(meth) acrylate, cyclohexyl(meth) acrylate, benzyl(meth) acrylate, β-carboxyethyl acrylate, ethylene glycol di(meth) acrylate, diethylene glycol di(meth) acrylate, triethylene glycol di(meth)acrylate, 1,4-butanediol di(meth)acrylate, 1,9-nonanediol di(meth)acrylate, 1,10-decanediol di(meth)acrylate, neopentyl glycol di(meth)acrylate, 1,6-hexanediol di(meth)acrylate, trimethylolpropane tri(meth)acrylate, lyserine di(meth)acrylate, dimethylol-tricyclodecanedi(meth)acrylate, pentaerythritol tri(meth) acrylate, pentaerythritol tetra(meth) acrylate, dipentaerythritol hexa(meth) acrylate, 2-hydroxy-3-acryloyloxypropyl(meth) acrylate, hydroxypivalic acid neopentyl glycol di(meth) acrylate, ditrimethylolpropane tetra(meth) acrylate, 2-butyl-2-ethyl-1,3-propanediol di(meth) acrylate, or polytetramethylene glycol di(meth) acrylate, but the inventive concepts are not limited to these examples.

The crosslinking agent may include, for example, an isocyanate-based crosslinking agent or an epoxy-based crosslinking agent. The isocyanate-based crosslinking agent may include, for example, alicyclic isocyanates, aromatic isocyanates, and isocyanate adducts, but the inventive concepts are not limited to these examples.

Specifically, the alicyclic isocyanate may include lower aliphatic polyisocyanates, such as butylene diisocyanate and hexamethylene diisocyanate, cyclopentylene diisocyanate, cyclohexylene diisocyanate, isophorone diisocyanate, etc., but the inventive concepts are not limited to these examples. The aromatic isocyanate may include 2,4-tolylene diisocyanate, 4,4′-diphenylmethane diisocyanate, xylylene diisocyanate, etc., but is not limited thereto. The isocyanate adduct may include trimethylolpropane/tolylene diisocyanate trimer adduct, trimethylolpropane/hexamethylene diisocyanate trimer adduct, isocyanurate of hexamethylene diisocyanate, and the like, but the inventive concepts are not limited to these examples.

The epoxy-based crosslinking agent may include, for example, N,N,N′,N′-tetraglycidyl-m-xylenediamine, diglycidylaniline, 1,3-bis(N,N-glycidylaminomethyl) cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, poly propylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane poly glycidyl ether, adipic acid diglycidyl ester, o-phthalic acid diglycidyl ester, triglycidyl-tris (2-hydroxyethyl) isocyanurate, resorcinol diglycidyl ether, bisphenol-S-diglycidyl ether, etc., but the inventive concepts are not limited to these examples.

The light absorber may include at least one selected from the group consisting of a cyanoacrylate-based compound and a sterically hindered amine-based compound.

In an embodiment, the cyanoacrylate-based compound may have a ring structure. In an embodiment, the cyanoacrylate-based compound having the ring structure may be represented by Formulae 1A and 1B below:

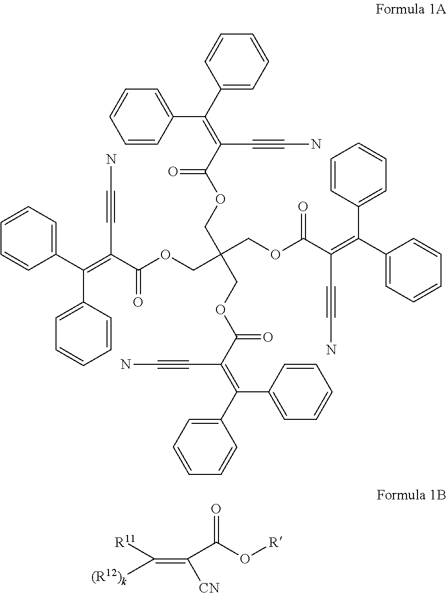

Here, R′ is an organic group having 1 to 20 carbon atoms, R¹¹ and R¹² are each independently an aryl group even with a substituent, and k is 0 or 1.

Here, the aryl group represented by R¹¹ and R¹² is not particularly limited in number of carbon atoms, but, in some embodiments, may have 6 to 14 carbon atoms. Specific examples of such an aryl group include a phenyl group, a tolyl group, a xylyl group, a naphthyl group, an anthryl group, and a phenanthryl group. The aryl group may have a substituent. Examples of such a substituent include a C₁-C₁₂ alkoxy group, such as a methoxy group, an ethoxy group, a propoxy group, a butoxy group, a hexoxy group, a 2-ethylhexoxy group, an octoxy group, and a dodecyloxy group; and a C₁-C₄ alkylene dioxy group, such as a methylenedioxy group and ethylenedioxy group, etc., but the inventive concepts are not limited to these examples.

Specifically, the cyanoacrylate-based compound having a ring structure may include ethyl-2-cyano-3,3-diphenyl acrylate, 2′-ethylhexyl-2-cyano-3,3-diphenyl acrylate, ethyl-2-cyano-3-(3′,4′-methylenedioxyphenyl)-2-acrylate, 2′-ethylhexyl-2-cyano-3-(3″,4″-methylenedioxy phenyl)-2-acrylate, dodecyl-2-cyano-3-(3′,4′-methylenedioxyphenyl)-2-acrylate, methyl-2-cyano-3,3-diphenyl acrylate, ethyl-2-cyano-3,3-ditolyl acrylate, ethyl-2-cyano-3,3-dinaphthyl acrylate, and the like, but the inventive concepts are not limited to these examples.

In an embodiment, the sterically hindered amine-based compound may have a ring structure. The sterically hindered amine-based compound having a ring structure may be represented Formulae 2A to 2D below:

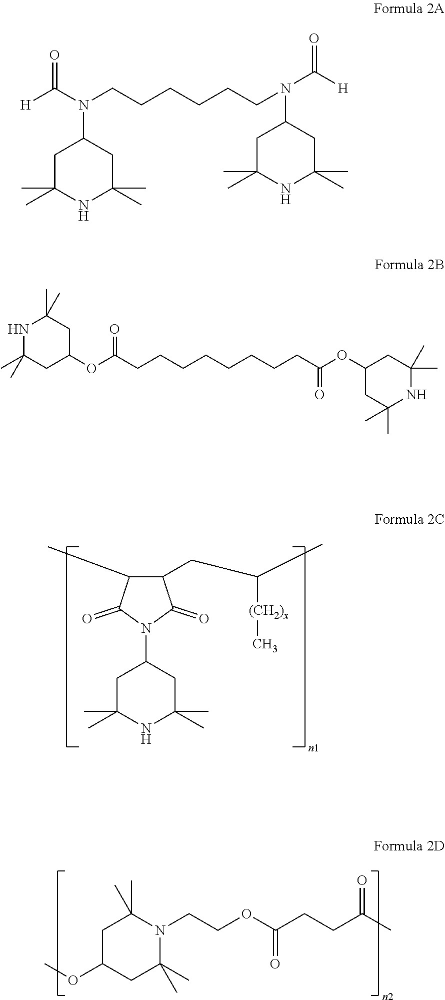

Here, n₁ and n₂ are each independently an integer of 2 to 20, and x is an integer of 17 to 21.

In an embodiment, the light absorber may absorb ultraviolet light having a wavelength of 350 nm or less. For example, the light absorber may absorb ultraviolet rays having a wavelength in a range of about 10 nm to about 350 nm, ultraviolet rays having a wavelength in a range of about 100 nm to about 330 nm, or ultraviolet rays having a wavelength in a range of about 200 nm to about 310 nm.

In an embodiment, the content of the light absorber may be in a range of about 0.01 wt % to about 10 wt % based on the entire adhesive composition layer 110. For example, the content of the light absorber may be in a range of about 0.01 wt % to about 10 wt %, about 0.01 wt % to about 5 wt %, or about 0.1 wt % to about 1 wt %, based on the total amount of the adhesive composition layer 110.

The adhesive composition layer 110 according to another embodiment of the inventive concept includes an acrylate-based resin, an isocyanate-based crosslinking agent, a first light absorber, and a second light absorber, wherein the first light absorber and the second light absorber may include at least one selected from the group consisting of a benzophenone-based compound, a cyanoacrylate-based compound having a ring structure, a benzotriazole-based compound, and a sterically hindered amine-based compound having a ring structure, and the first light absorber and the second light absorber may be different from each other.

In an embodiment, the cyanoacrylate-based compound having a ring structure may be represented by previously described Formulae 1A and 1B.

In an embodiment, the sterically hindered amine-based compound having a ring structure may be represented by previously described Formulae 2A to 2D.

In an embodiment, the benzotriazole-based compound may be represented by Formula 3 below:

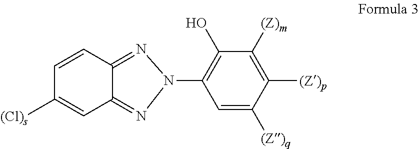

Here, Z, Z′, and Z″ are each independently an organic group having 1 to 20 carbon atoms, and m, p, q, and s are each independently 0 or 1.

The organic group having 1 to 20 carbon atoms and represented by Z, Z′ and Z″ may include: an alkyl group, such as a methyl group, a t-butyl group, a t-pentyl group, an octyl group, a dodecyl group, etc.; an alkoxycarbonylalkyl group, such as a methoxycarbonylethyl group, an octoxycarbonylethyl group, etc.; a polyoxyalkylenecarbonylalkyl group, such as a polyoxyethyleneoxycarbonylmethyl group, etc.; an aryl group, such as a phenyl group, a butylphenyl group, a sec-butylphenyl group, a t-butylphenyl group, etc.; an arylalkyl group, such as a benzyl group, a phenylethyl group, etc.; an acyloxy group, such as an acetoxy group, a butyryloxy group, a benzoyloxy group, a naphthoyloxy group, a furoyloxy group, a methacryloyloxy group, an acryloyloxy group, etc.; an imide group substituted with an N-alkyl group, such as a tetrahydrophthalimidylmethyl group, a maleimidylmethyl group, etc., but the inventive concepts are not limited to these examples.

Specifically, the benzotriazole-based compound may be represented as follows:

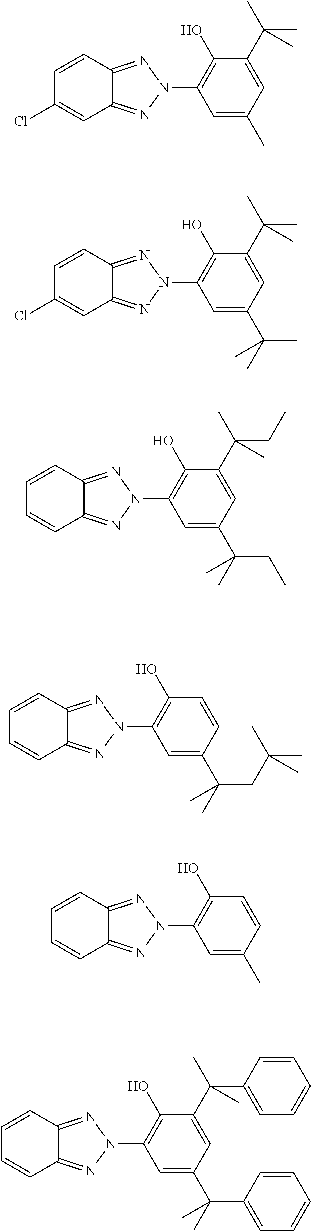 [SMILES: Cc1cc(-n2nc3ccc(Cl)cc3n2)c(O)c(C(C)(C)C)c1 ; CC(C)(C)c1cc(-n2nc3ccc(Cl)cc3n2)c(O)c(C(C)(C)C)c1 ; CCC(C)(C)c1cc(-n2nc3ccccc3n2)c(O)c(C(C)(C)CC)c1 ; CC(C)(C)CC(C)(C)c1ccc(O)c(-n2nc3ccccc3n2)c1 ; Cc1ccc(O)c(-n2nc3ccccc3n2)c1 ; CC(C)(c1ccccc1)c1cc(-n2nc3ccccc3n2)c(O)c(C(C)(C)c2ccccc2)c1]

In an embodiment, the benzophenone-based compound may include, for example, 2,4-dihydroxybenzophenone, 2,2′-dihydroxy-4, 4′-dimethoxybenzophenone, 2-hydroxy-4-methoxybenzophenone, 2-hydroxy-4-n-octyloxybenzophenone, 2, 2′, 4, 4′-tetrahydroxybenzophenone, etc., but the inventive concepts are not limited to these examples.

In an embodiment, the first light absorber and the second light absorber may be different from each other. For example, the first light absorber may be a sterically hindered amine-based compound having a ring structure, and the second light absorber may be a benzotriazole-based compound.

In an embodiment, the total content of the first light absorber and the second light absorber may be in a range of about 0.01 wt % to about 10 wt % based on the total amount of the adhesive composition layer 110. For example, the total content of the first light absorber and the second light absorber may be in a range of about 0.01 wt % to about 10 wt %, about 0.01 wt % to about 5 wt %, or about 0.1 wt % to about 1 wt %.

In an embodiment, the first light absorber and the second light absorber may absorb ultraviolet rays having a wavelength of 350 nm or less. For example, the first light absorber and the second light absorber may absorb ultraviolet rays having a wavelength in a range of about 10 nm to about 350 nm, ultraviolet rays having a wavelength in a range of about 100 nm to about 330 nm, or ultraviolet rays having a wavelength in a range of about 200 nm to about 310 nm.

In an embodiment, the adhesive composition layer 110 may include an optional additive. The optional additive may include, for example, a tackifier, a plasticizer, a pigment, a dye, a filler, an anti-aging agent, a conductive material, an antistatic agent, a release control agent, a softener, a surfactant, a flame retardant, an antioxidant, and the like, but the inventive concepts are not limited thereto.

The tackifier may include, for example, a rosin-based tackifying resin (e.g., unmodified rosin, modified rosin, rosin phenol-based resin, rosin ester-based resin, etc.), a terpene-based tackifying resin (e.g., a terpene-based resin, a terpene phenol-based resin, styrene-modified terpene-based resin, an aromatic modified terpene-based resin, a hydrogenated terpene-based resin), a hydrocarbon-based tackifying resin (e.g., an aliphatic hydrocarbon resin, an aliphatic cyclic hydrocarbon resin, an aromatic hydrocarbon resin (for example, a styrene-based resin, a xylene-based resin, etc.), an aliphatic/aromatic petroleum resin, an aliphatic/alicyclic petroleum resin, a hydrogenated hydrocarbon resin, a coumarone-based resin, a coumaron-indene-based resin, etc.), a phenolic tackifying resin (for example, an alkylphenol-based resin, a xyleneformaldehyde-based resin, resol, novolac, etc.), a ketone-based tackifying resin, a polyamide-based tackifying resin, an epoxy-based tackifying resin, an elastomer-based tackifying resin, etc., but, the present inventive concept is not limited thereto.

The plasticizer may include, for example, a mellitic acid ester-based plasticizer, a pyromellitic acid ester-based plasticizer, a polyester-based plasticizer, or an adipic acid-based plasticizer, but the inventive concepts are not limited to these examples. In an embodiment, the plasticizer may be used alone or in combination of two or more plasticizers.

In an embodiment, the adhesive composition layer 110 may further include a silicone release layer. Since the adhesive composition layer 110 includes a silicone release layer, adhesion between a wafer and the adhesive composition layer 110 may further be strengthened.

Since the cyanoacrylate-based compound having a ring structure and the sterically hindered amine-based compound having a ring structure are included in the adhesive composition layer 110, the adhesive composition layer 110 may absorb ultraviolet rays having a wavelength of 350 nm or less.

A wafer processing tape 100 according to another embodiment of the present inventive concept may include a base film 120 and an adhesive composition layer 110 that is disposed on the base film 120, includes a resin, a crosslinking agent, and a first light absorber, wherein the first light absorber includes at least one selected from the group consisting of a benzophenone-based compound, a cyanoacrylate-based compound having a ring structure, a benzotriazole-based compound, and a sterically hindered amine-based compound having a ring structure.

In an embodiment, a vertical thickness of the adhesive composition layer 110 may be in a range of about 10 μm to about 500 μm. For example, the vertical thickness of the adhesive composition layer 110 may range from about 10 μm to about 500 μm, from about 50 μm to about 300 μm, or from about 100 μm to about 200 μm.

In an embodiment, the cyanoacrylate-based compound having a ring structure may be represented by previously described Formulae 1A and 1B.

In an embodiment, the sterically hindered amine-based compound having a ring structure may be represented by previously described Formulae 2A to 2D.

In an embodiment, the benzotriazole-based compound may be represented by previously described Formula 3.

In an embodiment, specifically, the benzophenone-based compound may include, 2,4-dihydroxybenzophenone, 2,2′-dihydroxy-4, 4′-dimethoxybenzophenone, 2-hydroxy-4-methoxybenzophenone, 2-hydroxy-4-n-octyloxybenzophenone, 2, 2′, 4, 4′-tetrahydroxy benzophenone, etc., but the inventive concepts are not limited to these examples.

In an embodiment, the content of the first light absorber may be in a range of about 0.01 wt % to about 10 wt % based on the entire adhesive composition layer 110. For example, the content of the first light absorber may be in a range of about 0.01 wt % to about 10 wt %, about 0.01 wt % to about 5 wt %, or about 0.1 wt % to about 1, based on the total amount of the adhesive composition layer 110.

In an embodiment, the adhesive composition layer 110 of the wafer processing tape 100 may include at least one selected from the group consisting of a benzophenone-based compound, a cyanoacrylate-based compound having a ring structure, a benzotriazole-based compound, and a sterically hindered amine-based compound having a ring structure and a second light absorber different from the first light absorber, wherein the total content of the first light absorber and the second light absorber may be in a range of about 0.01 wt % to about 1 wt % based on the total amount of the adhesive composition layer 110. For example, the first light absorber may include a cyanoacrylate-based compound having a ring structure, and the second light absorber may include a sterically hindered amine-based compound having a ring structure.

In an embodiment, the wafer processing tape 100 may further include an adhesive layer 130 between the base film 120 and the adhesive composition layer 110. In an embodiment, the adhesive layer 130 may include, for example, an acrylate-based compound. Since the wafer processing tape 100 further includes the adhesive layer 130, an adhesive force between an interface of the base film 120 and an interface of the adhesive composition layer 110 may be improved. In some embodiments, the adhesive layer 130 may be omitted.

Since the cyanoacrylate-based compound having a ring structure and the sterically hindered amine-based compound having a ring structure are included in the adhesive composition layer 110, the adhesive composition layer 110 may absorb ultraviolet rays having a wavelength of 350 nm or less. Since the adhesive composition layer 110 absorbs ultraviolet rays having a wavelength of 350 nm or less, it is possible to prevent the base film 120 from being decomposed by ultraviolet rays having a wavelength of 350 nm or less during a process of manufacturing a semiconductor device. Accordingly, the stability of the wafer processing tape 100 including the adhesive composition layer 110 may be improved, and the reliability of a semiconductor device manufactured by using the wafer processing tape 100 may be improved.

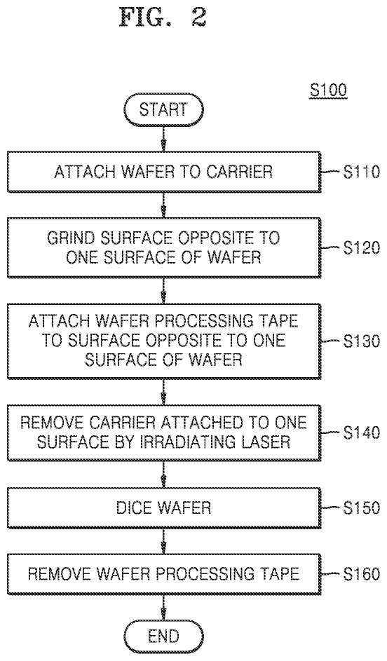

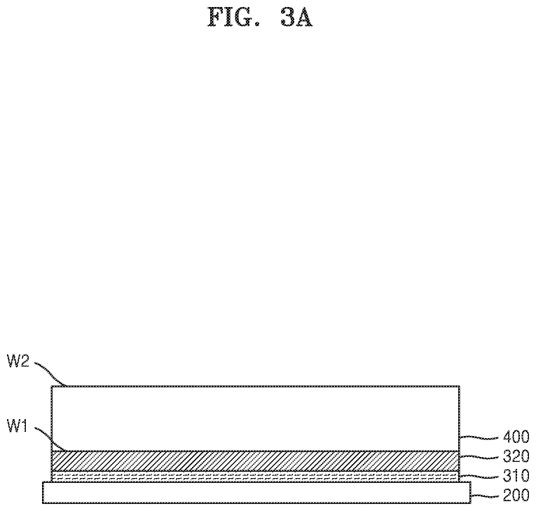

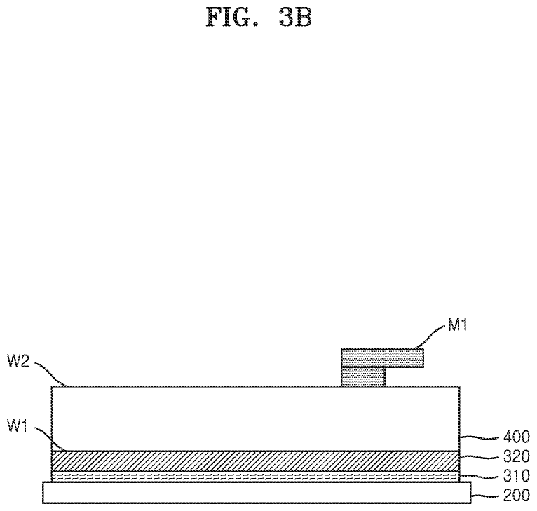

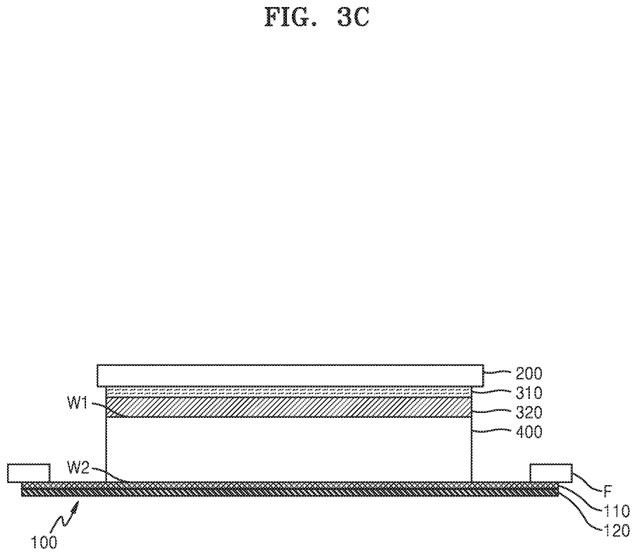

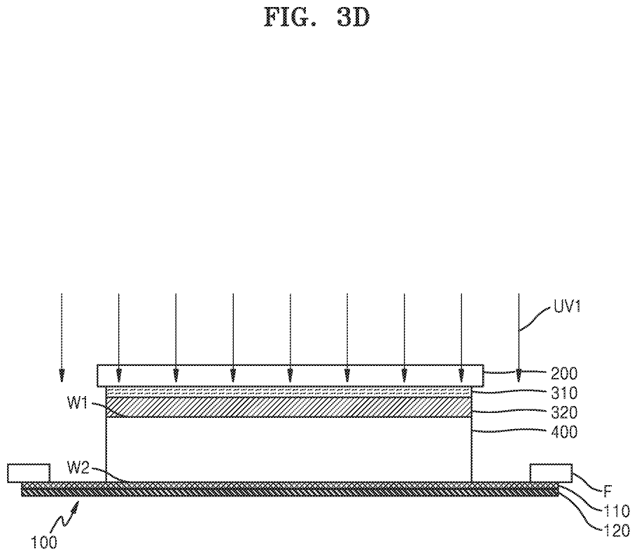

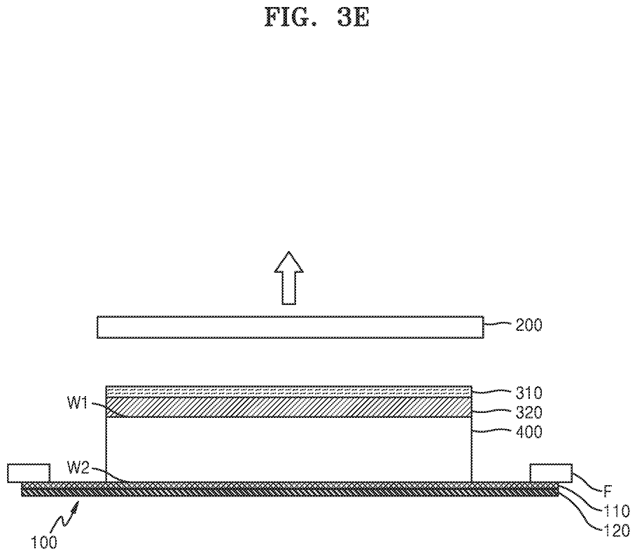

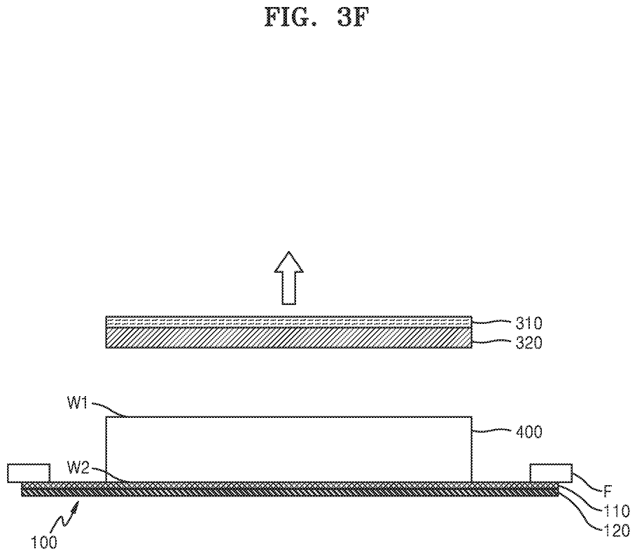

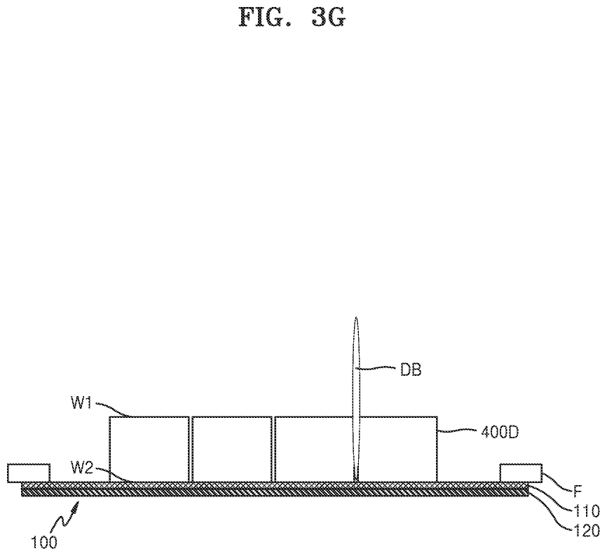

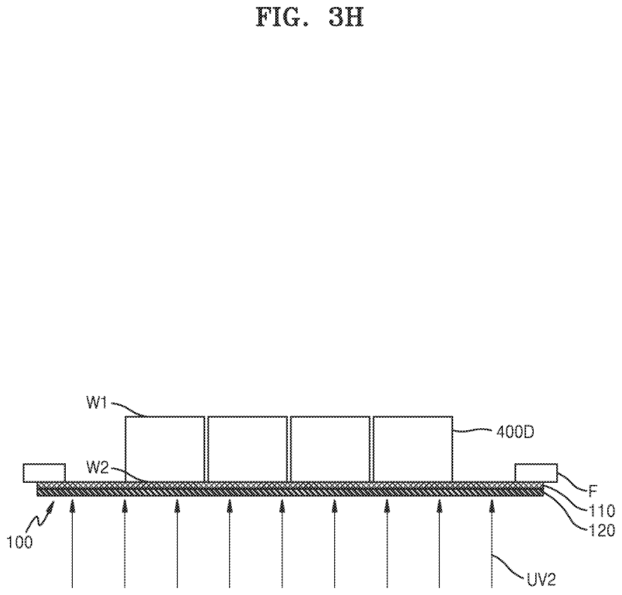

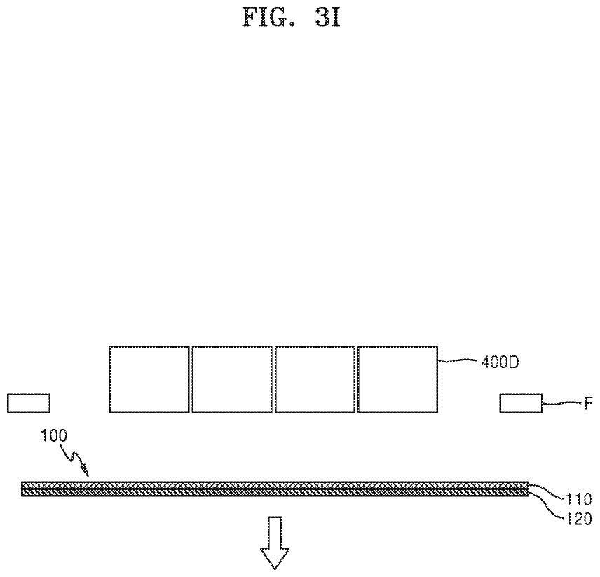

FIG. 2 is a flowchart for reference in describing a wafer processing method using a wafer processing tape. FIGS. 3A to 3I are cross-sectional views illustrating a wafer processing method using a wafer processing tape.

Referring to FIGS. 2 and 3A, a wafer 400 may be attached to a carrier 200 (S110). First, after a release layer 310 is coated on the carrier 200, a UV curing resin layer 320 may be coated on the release layer 310. The UV curing resin layer 320 may be coated, for example, by spin-coating, but is not limited thereto. After the UV curing resin layer 320 is coated on the release layer 310, the wafer 400 may be attached to the UV curing resin layer 320. In this case, one surface W1 of the wafer 400 may be in contact with an upper surface of the UV curing resin layer 320. The carrier 200 may be, for example, a glass carrier, but the inventive concepts are not limited to this example.

Referring to FIGS. 2 and 3B, a surface W2 opposite to the one surface W1 of the wafer 400 may be ground by a wafer grinding apparatus M1 (S120). As the wafer 400 is ground, a vertical thickness of the wafer 400 may be reduced.

Referring to FIGS. 2 and 3C, the wafer processing tape 100 including the adhesive composition layer 110 and the base film 120 may be attached to the surface W2 opposite to the one surface W1 of the wafer 400 (S130). First, after the wafer 400 and the carrier 200 are turned over, the wafer processing tape 100 may be attached to the surface W2 opposite to the one surface W1 of the wafer 400. At this time, the wafer processing tape 100 is attached so that the surface W2 opposite to the one surface W1 of the wafer 400 is in contact with the adhesive composition layer 110 of the wafer processing tape 100. Then, the wafer processing tape 100 may be fixed by a ring frame F. In this case, a horizontal width of the wafer processing tape 100 may be greater than a horizontal width of the wafer 400.

Referring to FIGS. 2 and 3D to 3F, the carrier 200 attached to the one surface W1 of the wafer 400 may be removed by irradiating a laser (S140). First, ultraviolet rays UV1 may be irradiated from the one surface W1 toward the surface W2 opposite to the one surface W1 of the wafer 400. The ultraviolet rays UV1 may be, for example, ultraviolet rays having a wavelength of 350 nm or less. When ultraviolet rays UV1 are irradiated, the carrier 200 may be separated and removed from the release layer 310. Afterwards, the release layer 310 and the UV curing resin layer 320 may be removed. In operation S140, because the horizontal width of the wafer processing tape 100 is greater than the horizontal width of the wafer 400, some of the ultraviolet rays UV1 may not be covered by the wafer 400, but may be irradiated to the adhesive composition layer 110 included in the exposed wafer processing tape 100. The adhesive composition layer 110 included in the wafer processing tape 100 according to an embodiment of the inventive concept includes a light absorber that absorbs ultraviolet rays having a wavelength of 350 nm or less, and the light absorber absorbs ultraviolet rays having a wavelength of 350 nm or less. Therefore, the separation of the adhesive composition layer 110 from the base film 120 may be prevented. Accordingly, the reliability of a semiconductor device manufactured by using the semiconductor device manufacturing process using the wafer processing tape 100 may be improved.

Referring to FIGS. 2 and 3G, the wafer 400 may be diced (S150). A dicing blade DB may dice the wafer 400, and accordingly, the wafer 400 may be divided into individual chips 400D.

Referring to FIGS. 2, 3H, and 3I, the wafer processing tape 100 may be removed from the individual chips 400D (S160). First, ultraviolet rays UV2 may be irradiated in a direction from the surface W2 opposite to the one surface W1 of the individual chips 400D toward the one surface W1. The wafer processing tape 100 may absorb ultraviolet rays having a wavelength of 350 nm or less. Accordingly, the ultraviolet rays UV2 irradiated to remove the wafer processing tape 100 may be ultraviolet rays having a wavelength of 350 nm or more. When the ultraviolet rays UV2 is irradiated, and wafer processing tape 100 may be removed from the surface W2 opposite to the one surface W1 of the wafer 400.

As described above, example embodiments of the inventive concept have been disclosed in the drawings and specification. In the present specification, the example embodiments are described by using some specific terms, but the terms used are for the purpose of describing the technical scope of the inventive concept only and are not intended to be limiting of meanings or the technical scope described in the claims. Therefore, it will be understood by those skilled in the art that various changes in form and details may be made therein without departing from the spirit and scope of the inventive concept as defined by the appended claims. Accordingly, the scope of the invention is defined not by the detailed description of the invention but by the appended claims.

While the inventive concept has been particularly shown and described with reference to embodiments thereof, it will be understood that various changes in form and details may be made therein without departing from the spirit and scope of the following claims.

What is claimed is:

1. An adhesive composition comprising a resin, a crosslinking agent, and a light absorber, wherein the light absorber includes at least one selected from the group consisting of a benzophenone-based compound, a cyanoacrylate-based compound having a ring structure, a benzotriazole-based compound, and a sterically hindered amine-based compound having a ring structure.

2. The adhesive composition of claim 1, wherein the light absorber absorbs ultraviolet rays having a wavelength of 350 nm or less.

3. The adhesive composition of claim 1, wherein the cyanoacrylate-based compound having the ring structure is any one of compounds represented by Formulae 1A and 1B: 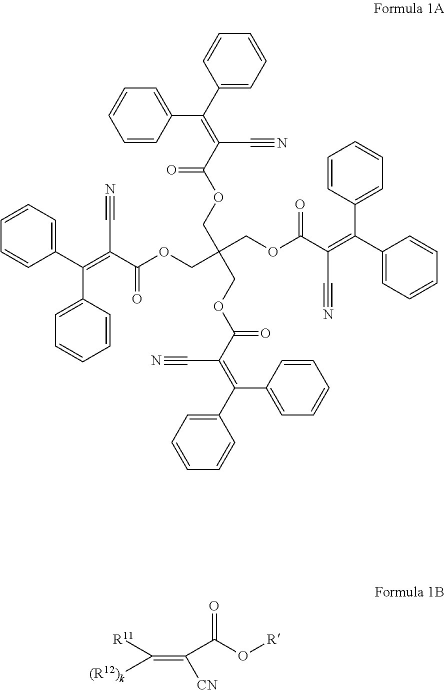
where R′ is an organic group having 1 to 20 carbon atoms, R¹¹ and R¹² are each independently an aryl group even with a substituent, and k is 0 or 1.

4. The adhesive composition of claim 1, wherein the sterically hindered amine-based compound having the ring structure is any one of compounds represented by Formulae 2A to 2D: 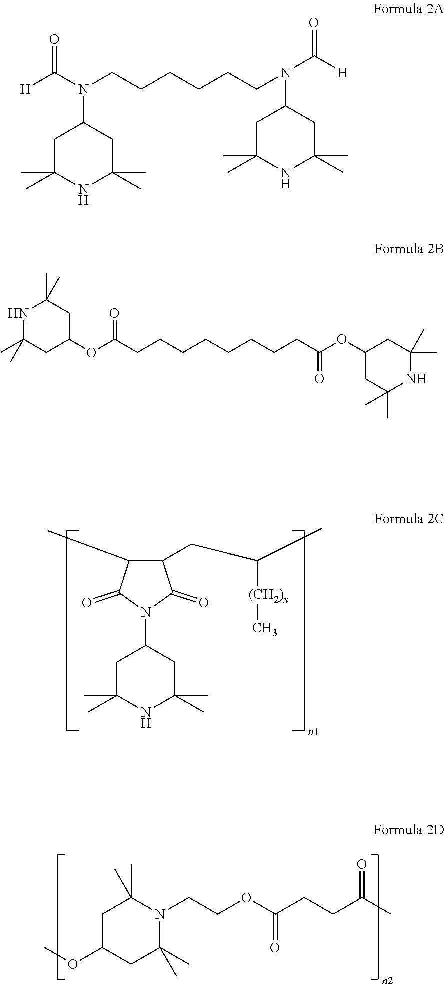
where n₁ and n₂ are each independently an integer of 2 to 20, and x is an integer of 17 to 21.

5. The adhesive composition of claim 1, wherein a content of the light absorber is in a range of about 0.01 wt % to about 10 wt % based on a total weight of the adhesive composition.

6. The adhesive composition of claim 1, wherein a content of the light absorber is in a range of about 0.01 wt % to about 1 wt % based on a total weight of the adhesive composition.

7. An adhesive composition comprising an acrylate-based resin, an isocyanate-based crosslinking agent, a first light absorber, and a second light absorber, wherein the first light absorber and the second light absorber include at least one selected from the group consisting of a benzophenone-based compound, a cyanoacrylate-based compound having a ring structure, a benzotriazole-based compound, and a sterically hindered amine-based compound having a ring structure, and the first light absorber and the second light absorber are different from each other.

8. The adhesive composition of claim 7, wherein a total content of the first light absorber and the second light absorber is in a range of about 0.01 wt % to about 10 wt % based on a total amount of the adhesive composition.

9. The adhesive composition of claim 7, wherein the first light absorber and the second light absorber absorb ultraviolet rays having a wavelength of 350 nm or less.

10. The adhesive composition of claim 7, wherein the cyanoacrylate-based compound having a ring structure includes any one of compounds represented by Formulae 1A and 1B: 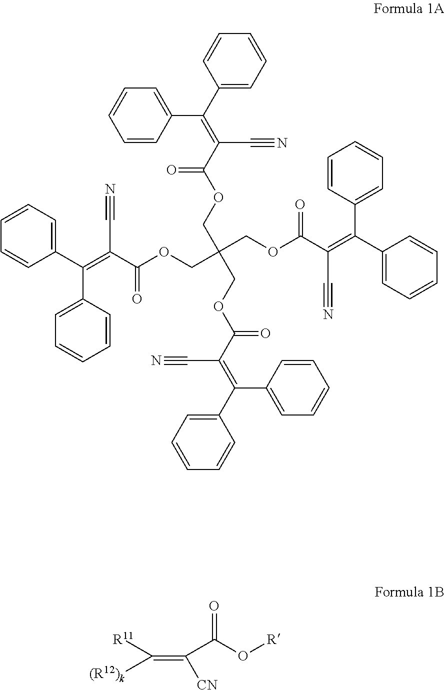
where R′ is an organic group having 1 to 20 carbon atoms, each of R¹¹ and R¹² are each independently an aryl group even with a substituent, and k is 0 or 1).

11. The adhesive composition of claim 7, wherein the sterically hindered amine-based compound having a ring structure is any one of compounds represented by Formulae 2A to 2D: 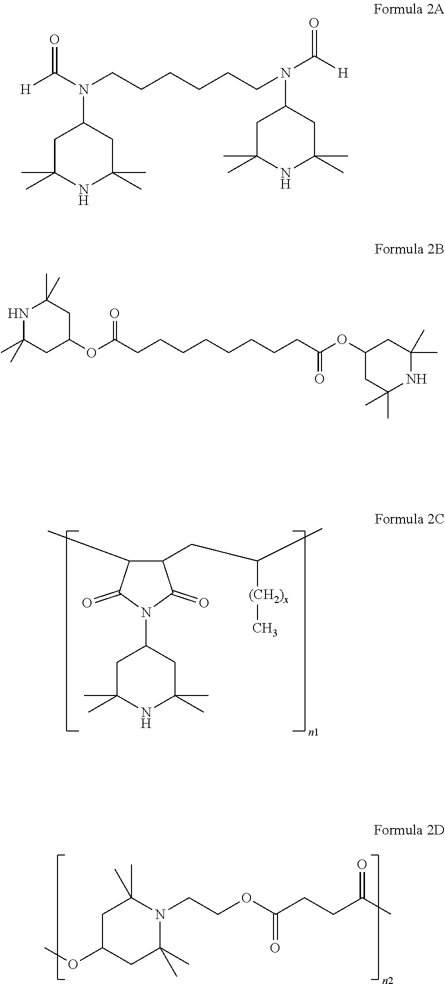
where n₁ and n₂ are each independently an integer of 2 to 20, and x is an integer of 17 to 21.

12. A wafer processing tape comprising:
a base film; and
an adhesive composition layer located on the base film and including a resin, a crosslinking agent, and a first light absorber, wherein the first light absorber includes at least one selected from the group consisting of a benzophenone-based compound, a cyanoacrylate-based compound having a ring structure, a benzotriazole-based compound, and a sterically hindered amine compound having a ring structure.

13. The wafer processing tape of claim 12, wherein the base film includes any one of polyether ether ketone (PEEK), polyimide (PI), polyethylene naphthalate (PEN), polyolefin (PO), and polyethylene terephthalate (PET).

14. The wafer processing tape of claim 12, wherein a vertical thickness of the adhesive composition layer is in a range of about 10 μm to about 500 μm.

15. The wafer processing tape of claim 12, wherein the cyanoacrylate-based compound having a ring structure is any one of compounds represented by Formulae 1A and 1B: 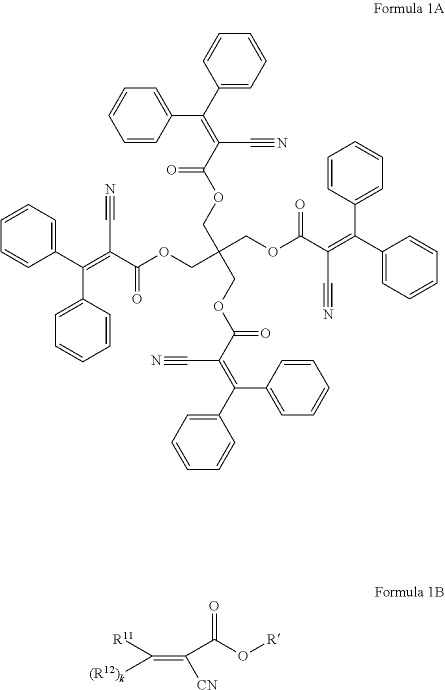
where R′ is an organic group having 1 to 20 carbon atoms, each of R¹¹ and R¹² are each independently an aryl group even with a substituent, and k is 0 or 1.

16. The wafer processing tape of claim 12, wherein the sterically hindered amine-based compound having a ring structure is any one of compounds represented by Formulae 2A to 2D: 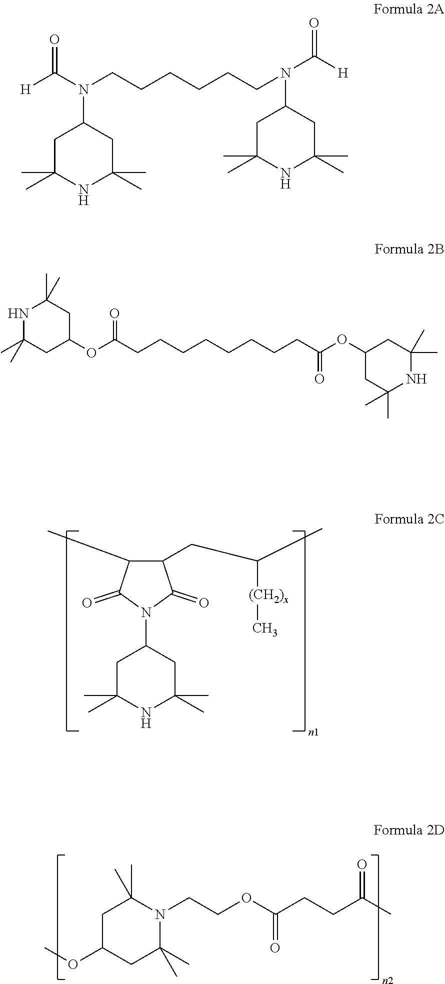
where n₁ and n₂ are each independently an integer of 2 to 20, and x is an integer of 17 to 21.

17. The wafer processing tape of claim 12, wherein a weight ratio of the first light absorber is in a range of about 0.01 wt % to about 1 wt % based on a total weight of the adhesive composition in the adhesive composition layer.

18. The wafer processing tape of claim 12, wherein the first light absorber absorbs ultraviolet rays having a wavelength of 350 nm or less.

19. The wafer processing tape of claim 12, wherein the adhesive composition includes at least one selected from the group consisting of a benzophenone-based compound, a cyanoacrylate-based compound having a ring structure, a benzotriazole-based compound, and a sterically hindered amine-based compound having a ring structure, and a second light absorber different from the first light absorber, wherein a total content of the first light absorber and the second light absorber is in a range of about 0.01 wt % to about 1 wt % based on a total amount of the adhesive composition in the adhesive composition layer.

20. The wafer processing tape of claim 12, further comprising an adhesive layer interposed between the base film and the adhesive composition layer.
